(19) United States
(12) Patent Application Publication
(10) Pub. No.: US 2026/0252010 A1
(43) Pub. Date: Aug. 27, 2026

(54) IMAGE FORMING APPARATUS

(71) Applicant: CANON KABUSHIKI KAISHA, Tokyo (JP)

(72) Inventors: YOSHIYUKI YAMAZAKI, Okinawa (JP); TERUHIKO SASAKI, Shizuoka (JP); TAKANORI YAMAMOTO, Shizuoka (JP); OSAMU NAGASAKI, Shizuoka (JP); AKINOBU HIRAYAMA, Shizuoka (JP); MOTOHIRO FURUSAWA, Shizuoka (JP)

(21) Appl. No.: 19/540,127

(22) Filed: Feb. 13, 2026

(30) Foreign Application Priority Data
Feb. 27, 2025 (JP) 2025-030776

(51) Int. Cl. G03G 15/00; G03G 21/16; G03G 21/18

(52) U.S. Cl. CPC G03G 15/5004; G03G 21/1619; G03G 21/1633; G03G 21/1647; G03G 21/1676; G03G 21/1864

(57) ABSTRACT

An image forming apparatus includes an apparatus body including an opening portion, a process cartridge, an opening/closing member configured to be pivotably supported by the apparatus body around a pivot axis, the pivot axis being positioned in a first end portion of the apparatus body opposite to a second end portion of the apparatus body in a direction of the rotational axis, and a power switch disposed on the apparatus body. The opening/closing member includes a gripping portion, the gripping portion being disposed on a side of the second end portion opposite to the first end portion of the apparatus body. The power switch is configured to switch on and off a power supply of the image forming apparatus by being operated in a predetermined direction from the second end portion toward the first end portion with respect to the direction of the rotational axis.

### BACKGROUND

### Field of the Technology

This disclosure relates to an image forming apparatus that forms an image on a sheet.

### Description of the Related Art

In electrophotographic image forming apparatuses (hereinafter, simply referred to as image forming apparatuses), image formation is performed on recording materials by forming toner images on electrophotographic photosensitive members (photosensitive drums or drums) and by directly or indirectly transferring the toner images onto the recording materials.

Generally, these image forming apparatuses use toner (developer) replenishment and the maintenance of various components. Therefore, cartridge type image forming apparatuses exist in which cartridges are configured to be detachably mounted with respect to the image forming apparatuses, and, thereby, the toner replenishment, the maintenance, and the like are enabled by replacing the cartridges.

The term “cartridge” refers to a component that includes at least one of a drum or process means, and are detachably mounted to main bodies (apparatus bodies) of the image forming apparatuses. The process means are means for performing the image formation, and, as those that function on the drums, principally include developing means, charging means, transferring means, discharging means, cleaning means, and the like. Examples of the cartridges include process cartridges, which incorporate a drum and at least one of the process means and are integrally and detachably mounted to the apparatus bodies, drum cartridges incorporating a drum, developing cartridges incorporating the developing means, and the like. Such cartridge types as described above allow for the easy toner replenishment and maintenance of the image forming apparatuses.

According to the specification of U.S. Publication No. 20180329345 A1, an image forming apparatus is disclosed which includes an access door covering an opening portion for mounting and detaching a toner cartridge and a process cartridge with respect to an apparatus body. The access door is opened and closed in a substantially horizontal direction.

However, the image forming apparatus disclosed in the specification of U.S. Publication No. 20180329345 A1 still leaves room for further usability improvements regarding operations of a power switch and the access door.

### SUMMARY

According to some embodiments of the present disclosure, an image forming apparatus includes an apparatus body including an opening portion, a process cartridge including a photosensitive drum which is configured to rotate around a rotational axis, the process cartridge being configured to be detachably mounted to the apparatus body through the opening portion, an opening/closing member configured to be pivotably supported by the apparatus body around a pivot axis, the pivot axis being positioned in a first end portion of the apparatus body opposite to a second end portion of the apparatus body in a direction of the rotational axis, and extending along a gravity direction, the opening/closing member being pivotable between a closed position where the opening/closing member covers the opening portion and an open position where the opening/closing member opens the opening portion, and a power switch disposed on the apparatus body. The opening/closing member includes a gripping portion configured to be gripped when the opening/closing member is operated from the closed position toward the open position, the gripping portion being disposed on a side of the second end portion opposite to the first end portion of the apparatus body in a case where the opening/closing member is positioned in the closed position. The power switch is configured to switch on and off a power supply of the image forming apparatus by being operated in a predetermined direction from the second end portion toward the first end portion with respect to the direction of the rotational axis.

Features of the present disclosure will become apparent from the following description of embodiments with reference to the attached drawings. The following description of embodiments is described by way of example.

### BRIEF DESCRIPTION OF THE DRAWINGS

FIG. 1A is a perspective view illustrating an image forming apparatus according to this embodiment with a process cartridge and a toner cartridge detached.

FIG. 1B is a perspective view illustrating the image forming apparatus with a front door closed.

FIG. 2 is a cross-sectional view illustrating an apparatus body with the process cartridge and the toner cartridge mounted.

FIG. 3 is a perspective view illustrating the image forming apparatus.

FIG. 4A is a cross-sectional view illustrating a door lock button.

FIG. 4B is a cross-sectional view illustrating a state in which the door lock button is pressed.

FIG. 5A is a cross-sectional view illustrating a tray lock button.

FIG. 5B is a cross-sectional view illustrating a state in which the tray lock button is pressed.

FIG. 6 is a perspective view illustrating a state in which a multi-purpose tray is opened.

FIG. 7 is a front view illustrating a side regulating plate.

FIG. 8 is a perspective view illustrating the image forming apparatus with a cassette pulled out.

FIG. 9A is a cross-sectional view illustrating a separation unit lock button.

FIG. 9B is a cross-sectional view illustrating a state in which the separation unit lock button is pressed.

FIG. 10 is a perspective view illustrating a state in which a separation unit is disengaged from the cassette.

FIG. 11 is a side view illustrating a positional relationship between a power switch and a gripping portion.

FIG. 12 is a perspective view illustrating an image forming apparatus according to a second embodiment.

FIG. 13 is a perspective view illustrating the image forming apparatus with the cassette pulled out.

FIG. 14 is a side view illustrating a positional relationship between a power switch and the gripping portion.

### DESCRIPTION OF THE EMBODIMENTS

### First Embodiment

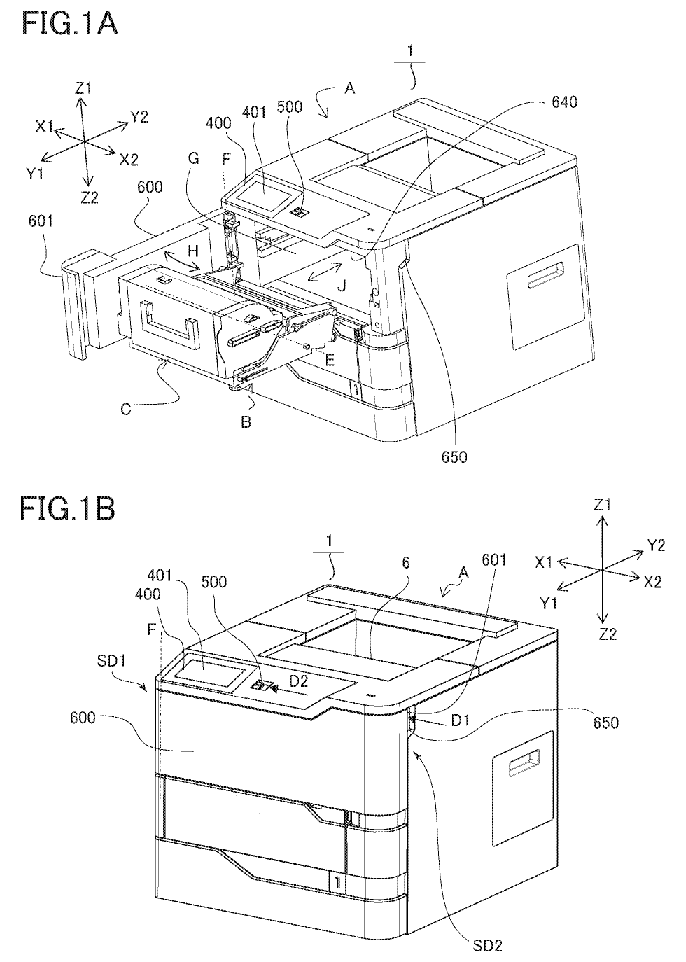

FIG. 1A is a perspective view illustrating an image forming apparatus 1 according to this embodiment with a process cartridge B and a toner cartridge C detached from an apparatus body A. FIG. 1B is a perspective view illustrating the image forming apparatus 1 with a front door 600 closed. In this embodiment, the image forming apparatus 1 is a monochrome laser printer. To be noted, the dimensions, materials, shapes, relative arrangements, and the like of the constituent components relating to the image forming apparatuses described in the embodiments described below may be appropriately modified according to configurations and various conditions of apparatuses to which this disclosure is applied. Therefore, unless otherwise specifically stated, the scope of this disclosure is not limited thereto.

In the following descriptions and drawings, a vertical direction in a case where the image forming apparatus 1 is installed on a horizontal surface is referred to as a Z-axis direction. A direction of a rotational axis (rotational axis direction) of a photosensitive drum 43 that the image forming apparatus 1 includes is referred to as an X-axis direction. A direction intersecting both the Z and X-axis directions is referred to as a Y-axis direction. The X, Y, and Z-axis directions may intersect orthogonally to each other. In addition, one side of the X-axis direction (the direction from a right side toward a left side) is referred to as an X1 direction, and the other side of the X-axis direction (the direction from the left side toward the right side) is referred to as an X2 direction. Similarly, one side of the Y-axis direction (the direction from a back side toward a front side) is referred to as a Y1 direction, and the other side of the Y-axis direction (the direction from the front side toward the back side) is referred to as a Y2 direction. One side of the Z-axis direction (the direction from a lower side toward an upper side) is referred to as a Z1 direction, and the other side of the Z-axis direction (the direction from the upper side toward the lower side) is referred to as a Z2 direction.

The Y1 direction may be referred to as the front side (anterior side) of the image forming apparatus 1. In addition, with reference to a state in which the image forming apparatus 1 is viewed from the front side, sides in the X2 and X1 directions may be respectively referred to as the right and left sides.

In addition, in a case where the process cartridge B and the toner cartridge C are mounted to the apparatus body A, the X-axis directions (X1 and X2 directions), the Y-axis directions (Y1 and Y2 directions), and the Z-axis directions (Z1 and Z2 directions) of the apparatus body A, the process cartridge B, and the toner cartridge C correspond to each other.

### Overall Configuration of Image Forming Apparatus

As illustrated in FIGS. 1A and 1B, the image forming apparatus 1 according to this embodiment includes the apparatus body A. The front door 600 is disposed on the front side of the apparatus body A, and the front door 600 is configured to pivot around a pivot axis F. A user can open and close the front door 600 in an H direction by gripping a gripping portion 601 disposed on a side opposite to the pivot axis F. The H direction is a direction along a horizontal direction.

When the front door 600 is opened, a space G for housing the process cartridge B and the toner cartridge C is exposed. The process cartridge B and the toner cartridge C are configured to be detachably mounted with respect to the apparatus body A in a J direction. The J direction is a direction along the horizontal direction. The pivot axis F of the front door 600 extends along a gravity direction (vertical direction, Z2 direction), and extends in a direction intersecting the J direction which serves as mounting and detachment directions of the process cartridge B and the toner cartridge C. Further, the pivot axis F of the front door 600 extends so as to intersect the direction of the rotational axis E of the photosensitive drum 43 which the process cartridge B described below includes.

In other words, in this embodiment, the pivot axis F extends in the Z-axis direction, the rotational axis E of the photosensitive drum 43 extends in the X-axis direction, and the J direction which serves as the mounting and detachment directions of the process cartridge B and the toner cartridge C is parallel to the Y-axis direction. That is, the direction of the rotational axis E is the X-axis direction.

The apparatus body A includes a display unit 400, and the display unit 400 includes a screen 401 that is constituted from, for example, a liquid crystal panel and is capable of displaying various types of information. On the screen 401 of the display unit 400, it is possible to display notifications to the user such as replacement prompts for the process cartridge B or the toner cartridge C, error notifications such as paper jam occurrence, and status information for the apparatus body A such as during printing or upon print completion.

The display unit 400 is disposed above the front door 600. In addition, the display unit 400 is disposed adjacent to the pivot axis F of the front door 600. With this arrangement, the user is enabled to easily perform an opening/closing operation of the front door 600 while viewing the display unit 400. A power switch 500 of the apparatus body A is arranged upstream of the screen 401 of the display unit 400 in the X1 direction. The power switch 500 can switch on and off a power supply of the image forming apparatus 1.

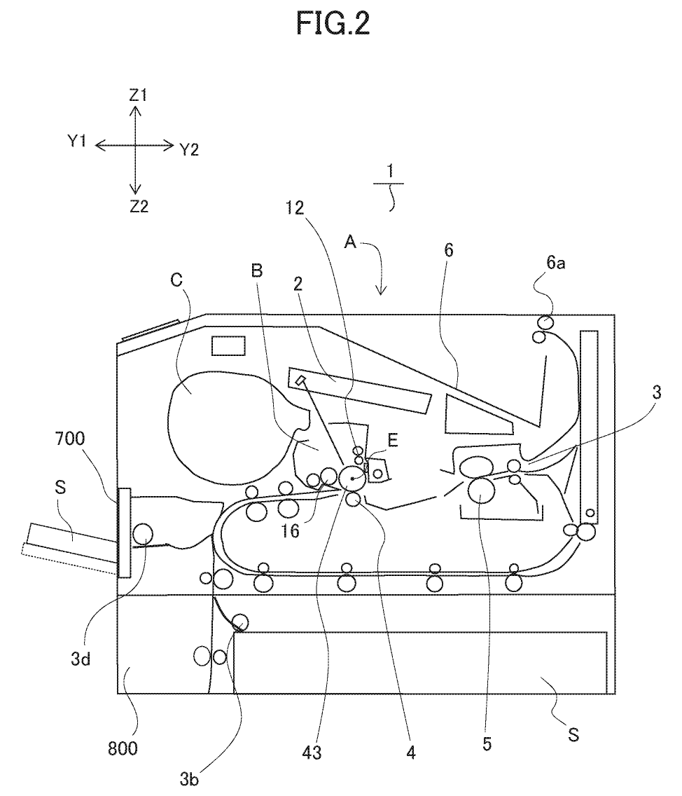

Next, with reference to FIG. 2, the apparatus body A, the process cartridge B, and the toner cartridge C will be described. FIG. 2 is a cross-sectional view illustrating the apparatus body A with the process cartridge B and the toner cartridge C mounted.

As illustrated in FIG. 2, in the apparatus body A, a sheet feed roller 3b for feeding the sheet to a sheet feed path 3, a multi-purpose feed roller 3d, a transfer roller 4, a fixing unit 5, and a laser scanner 2 are disposed. The process cartridge B of this embodiment includes the photosensitive drum 43, serving as an image bearing member, a developing roller 16 that bears toner, a charge roller 12, and the like. The photosensitive drum 43 is configured to rotate around the rotational axis E. The developing roller 16 supplies the toner to the photosensitive drum 43, and develops an electrostatic latent image formed on the photosensitive drum 43. The charge roller 12 is arranged to come in contact with an outer circumferential surface of the photosensitive drum 43, and charges the photosensitive drum 43 through voltage application (charge bias) from the apparatus body A. In addition, the charge roller 12 is rotatably driven by the photosensitive drum 43.

The toner cartridge C stores the toner that is supplied to the process cartridge B. In a state in which the process cartridge B and the toner cartridge C are mounted into the apparatus body A, the toner cartridge C communicates with a toner storage portion of the process cartridge B, and can supply the toner to the toner storage portion.

Next, with reference to FIG. 2, an operation of the image forming apparatus 1 will be described. The photosensitive drum 43 is rotatably driven by a drive source, not shown, and is uniformly charged to a predetermined potential by the charge roller 12. After being charged, the photosensitive drum 43 is exposed on its surface by the laser scanner 2 in accordance with image information; thereby, the charge is removed from exposed areas and the electrostatic latent image is formed. With respect the electrostatic latent image on the photosensitive drum 43, which has been formed as described above, the toner is supplied from the developing roller 16, and a toner image is formed on the photosensitive drum 43.

At this time, in parallel with the image forming process described above, the sheet S is conveyed along the sheet feed path 3. In particular, the sheet S stored in a cassette 800 is fed by the rotation of the sheet feed roller 3b, or the sheet S stacked on a multi-purpose tray 700 is fed by the rotation of the multi-purpose feed roller 3d. Thereafter, the sheet S is conveyed to a gap between the photosensitive drum 43 and the transfer roller 4 in synchronization with the timing of the formation of the toner image on the photosensitive drum 43. When passing through the gap between the photosensitive drum 43 and the transfer roller 4, the toner image is transferred onto the sheet S as an unfixed image by a transfer voltage applied to the transfer roller 4. Thereafter, the sheet S onto which the toner image has been transferred is conveyed to the fixing unit 5. The toner image on the sheet S conveyed to the fixing unit 5 is heated and pressed when passing through the fixing unit 5, and is fixed onto a surface of the sheet S. Next, the sheet S is discharged to a sheet discharge tray 6 by a sheet discharge roller pair 6a.

### Opening/closing Configuration of Front Door

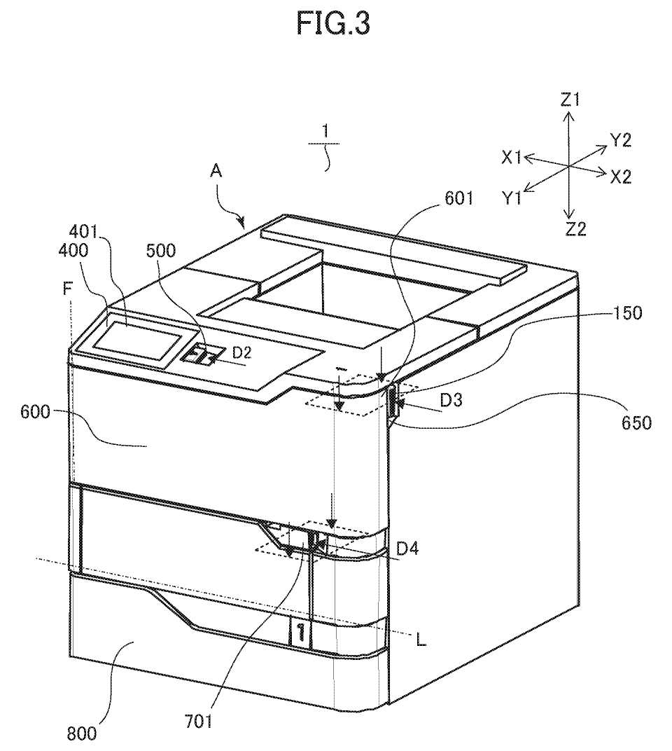

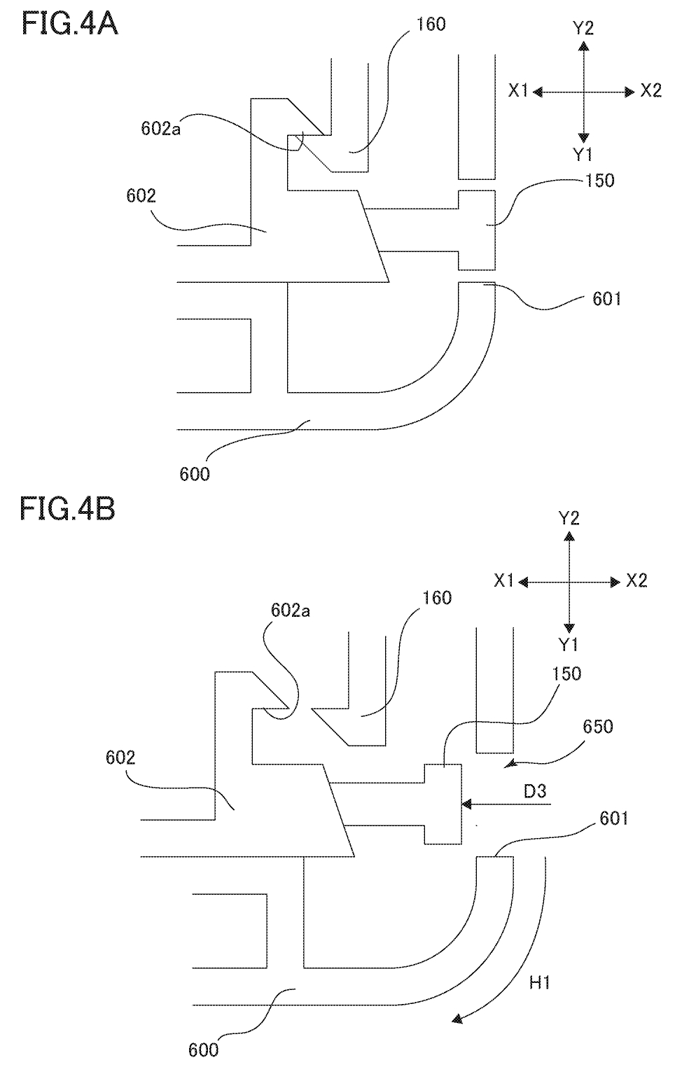

Next, a configuration for opening and closing the front door 600, serving as an opening/closing member, will be described using FIGS. 1A, 1B, 3, 4A, and 4B. FIG. 3 is a perspective view illustrating the image forming apparatus 1. FIG. 4A is a cross-sectional view illustrating a door lock button 150, and FIG. 4B is a cross-sectional view illustrating a state in which the door lock button 150 is pressed.

As illustrated in FIG. 1A, the front door 600 is, as described above, pivotably supported with respect to the apparatus body A around the pivot axis F, extending along the gravity direction (Z2 direction. The front door 600 is pivotable between a closed position covering an opening portion 640 disposed in the apparatus body A, and an open position exposing the opening portion 640. The process cartridge B and the toner cartridge C are detachably mounted with respect to the apparatus body A through the opening portion 640.

As illustrated in FIG. 1B, a concave portion 650 that is recessed in the X1 direction is disposed on a side surface in the X2 direction of the apparatus body A. Here, in the X-axis direction, which is the direction of the rotational axis E, a downstream end portion in the X1 direction of the apparatus body A is referred to as a first end portion SD1, and a downstream end portion in the X2 direction of the apparatus body A is referred to as a second end portion SD2. The pivot axis F of the front door 600 is positioned in the first end portion SD1. In addition, the concave portion 650 is disposed in the second end portion SD2.

Further, the gripping portion 601 of the front door 600 is disposed on a side of the second end portion SD2 when the front door 600 is positioned in the closed position. The concave portion 650 is arranged adjacent to the gripping portion 601 of front door 600 which is positioned in the closed position.

When pivoting the front door 600 from the closed position to the open position, the user inserts a hand in a D1 direction with respect to the concave portion 650, and operates to draw the front door 600 forward while gripping the gripping portion 601. In addition, the power switch 500 switches on and off the power supply of the image forming apparatus 1 by being operated in a D2 direction. These D1 and D2 directions are each parallel to the X1 direction, and are oriented in the same direction with respect to each other.

As illustrated in FIG. 3, the door lock button 150 is disposed in the concave portion 650. FIGS. 4A and 4B are cross-sectional views illustrating an upper broken line portion of FIG. 3. That is, FIGS. 4A and 4B are cross-sectional views taken along a plane parallel to an XY plane. As illustrated in FIG. 4A, a door engagement portion 160 is disposed in the apparatus body A, and a slide member 602 is supported by the front door 600 so as to be slidable in the X-axis direction. The door lock button 150 is disposed at an end portion in the X2 direction of the slide member 602. The slide member 602 is urged in the X2 direction by a spring, not shown, and is positioned at a lock position illustrated in FIG. 4A. To be noted, the slide member 602 and the door lock button 150 may be configured either as separate components or as an integrated assembly.

A lock portion 602a capable of engaging with the door engagement portion 160 is disposed in the slide member 602. When the slide member 602 is positioned at the lock position, the lock portion 602a engages with the door engagement portion 160. At this time, the lock portion 602a and the door engagement portion 160 are arranged to overlap when viewed in the Y-axis direction. That is, the front door 600 is locked in the closed position, and pivotal movement from the closed position to the open position is restricted. Therefore, even if the user grips the gripping portion 601 and draws the front door 600 in the Y1 direction, the front door 600 is retained in the closed position.

When opening the front door 600, as illustrated in FIG. 4B, the user inserts the hand into the concave portion 650, and presses the door lock button 150 in a D3 direction. Thereby, the slide member 602, integrated with the door lock button 150, moves in the X1 direction. Then, the engagement between the lock portion 602a of the slide member 602 and the door engagement portion 160 is released, and the movement restriction of the front door 600 from the closed position to the open position by the door engagement portion 160 is released.

By operating the gripping portion 601 of the front door 600 in the Y1 direction in this state, the user can pivot the front door 600 from the closed position toward the open position in an H1 direction. The D3 direction, which is an operation direction of the door lock button 150, is parallel to the X1 direction, and, as illustrated in FIG. 3, corresponds to the D2 direction, which is an operation direction of the power switch 500.

### Opening/closing Configuration of Multi-purpose Tray

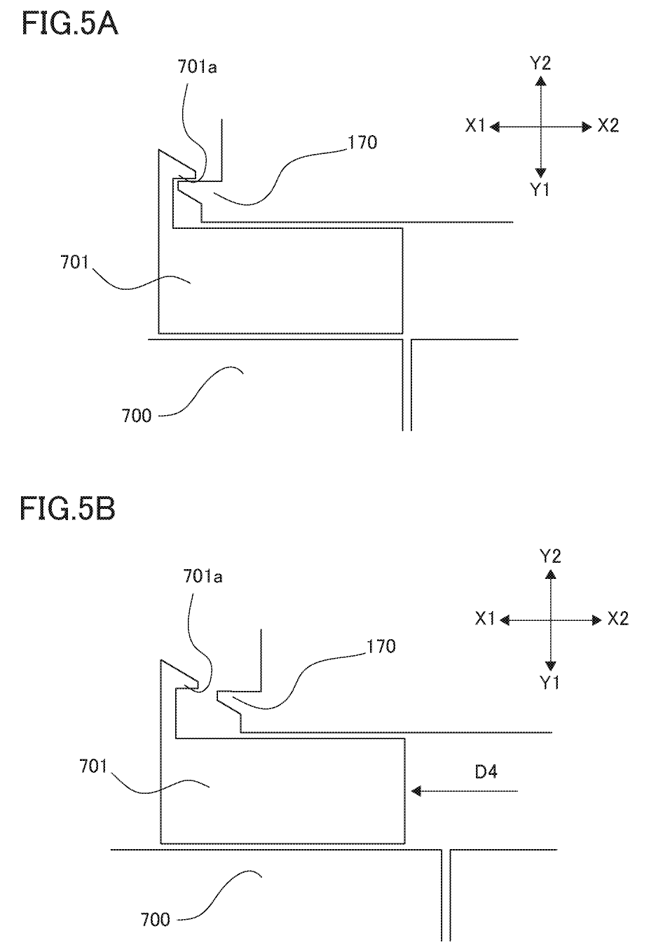

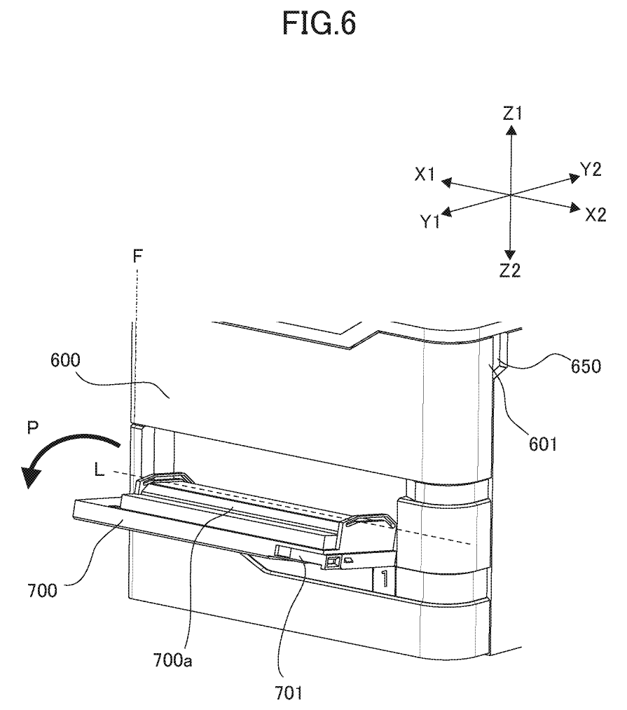

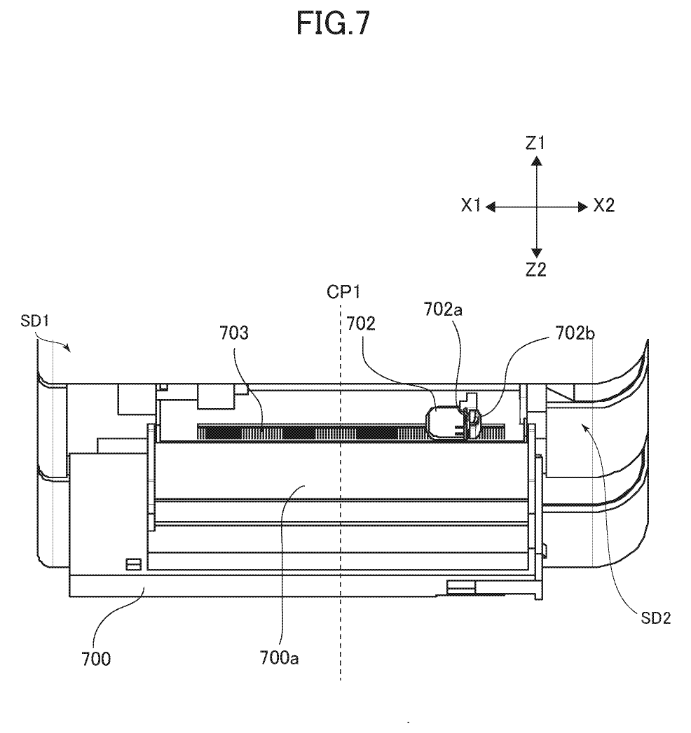

Next, using FIGS. 3 and 5A to 7, an opening/closing configuration of the multi-purpose tray 700 will be described. FIG. 5A is a cross-sectional view illustrating a tray lock button 701, and FIG. 5B is a cross-sectional view illustrating a state in which the tray lock button 701 is pressed. FIG. 6 is a perspective view illustrating a state in which the multi-purpose tray 700 is opened. FIG. 7 is a front view illustrating a side regulating plate 702.

As illustrated in FIGS. 3 and 6, beneath the front door 600, the multi-purpose tray 700 is supported with respect to the apparatus body A so as to be openable and closable around a pivot axis L. The multi-purpose tray 700, serving as a sheet supporting portion, can move to a closed position illustrated in FIG. 3, and an open position illustrated in FIG. 6, and includes a sheet supporting surface 700a which can support the sheet in the open position. The pivot axis L, serving as a second pivot axis, extends parallel to the direction of the rotational axis E of the photosensitive drum 43, i.e., in the X-axis direction. Therefore, the pivot axis L of the multi-purpose tray 700 extends to intersect the pivot axis F, serving as a first pivot axis, of the front door 600.

The multi-purpose tray 700 is pivoted downward from the closed position toward the open position. Therefore, even in a state in which the front door 600 is positioned in the open position, it is possible to move the multi-purpose tray 700 between the closed position and the open position without interfering with the front door 600. In addition, even when the front door 600 is open, a region of the multi-purpose tray 700 covered by the front door 600 is limited; thereby, it is possible to improve visibility of the sheet that is supported on the sheet supporting surface 700a of the multi-purpose tray 700, and it is possible to enhance usability.

As illustrated in FIGS. 3 and 6, the tray lock button 701, serving as a first regulating portion, is disposed in the muti-purpose tray 700. FIGS. 5A and 5B are cross-sectional views illustrating a lower broken line portion of FIG. 3. That is, FIGS. 5A and 5B are cross-sectional views taken along a plane parallel to the XY plane. As illustrated in FIG. 5A, a tray engagement portion 170 is disposed in the apparatus body A, and the tray lock button 701 is supported by the multi-purpose tray 700 so as to be slidable in the X-axis direction. The tray lock button 701 is urged in the X2 direction by a spring, not shown, and is positioned at a lock position illustrated in FIG. 5A.

A lock portion 701a capable of engaging with the tray engagement portion 170 is disposed in the tray lock button 701. When the tray lock button 701 is positioned at the lock position, the lock portion 701a engages with the tray engagement portion 170. At this time, the lock portion 701a and the tray engagement portion 170 are arranged to overlap when viewed in the Y-axis direction. That is, the multi-purpose tray 700 is locked in the closed position, and the pivotal movement from the closed position to the open position with respect to the apparatus body A is restricted. Therefore, even if the user grips the multi-purpose tray 700 and draws the multi-purpose tray 700 in the Y1 direction, the multi-purpose tray 700 is retained in the closed position.

When opening the multi-purpose tray 700, as illustrated in FIG. 5B, the user presses the tray lock button 701 in a D4 direction. Thereby, the tray lock button 701 moves in the X1 direction. Then, the engagement between the lock portion 701a of the tray lock button 701 and the tray engagement portion 170 is released, and the movement restriction of the multi-purpose tray 700 from the closed position to the open position by the tray engagement portion 170 is released. That is, when operated in the D4 direction (X1 direction), the tray lock button 701 allows the multi-purpose tray 700 to be opened with respect to the apparatus body A.

By operating the multi-purpose tray 700 in this state in the Y1 direction, the user can pivot the multi-purpose tray 700 from the closed position toward the open position in a P direction illustrated in FIG. 6. The D4 direction, which is an operation direction of the tray lock button 170, is parallel to the X1 direction, and, as illustrated in FIG. 3, corresponds to the D2 direction, which is the operation direction of the power switch 500.

As illustrated in FIG. 7, in a state in which the multi-purpose tray 700 is positioned in the open position, it is possible to stack the sheet on the sheet supporting surface 700a. A plurality of projecting portions 703, arranged along the X-axis direction, are disposed on the multi-purpose tray 700. In addition, a side regulating plate 702, serving as a moving unit, is supported on the multi-purpose tray 700 so as to be slidable in the X-axis direction. The side regulating plate 702 includes a regulating surface 702a that restricts a position in the X-axis direction of the sheet stacked on the sheet supporting surface 700a, and a release lever 702b.

The side regulating plate 702 is provided with an engagement claw, not shown, capable of engaging with the plurality of projecting portions 703, and, when the engagement claw engages with the plurality of projecting portions, the movement of the side regulating plate 702 with respect to the multi-purpose tray 700 is restricted. When the user grips the release lever 702b in the X-axis direction, the engagement claw is disengaged from the plurality of projecting portions 703. Thereby, the movement of the side regulating plate 702 with respect to the multi-purpose tray 700 is allowed.

### Disengagement Configuration of Separation Unit

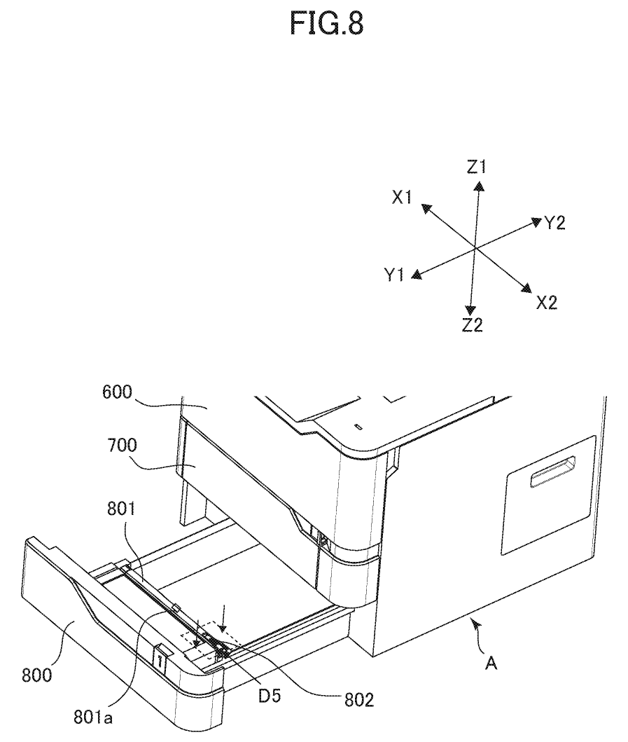

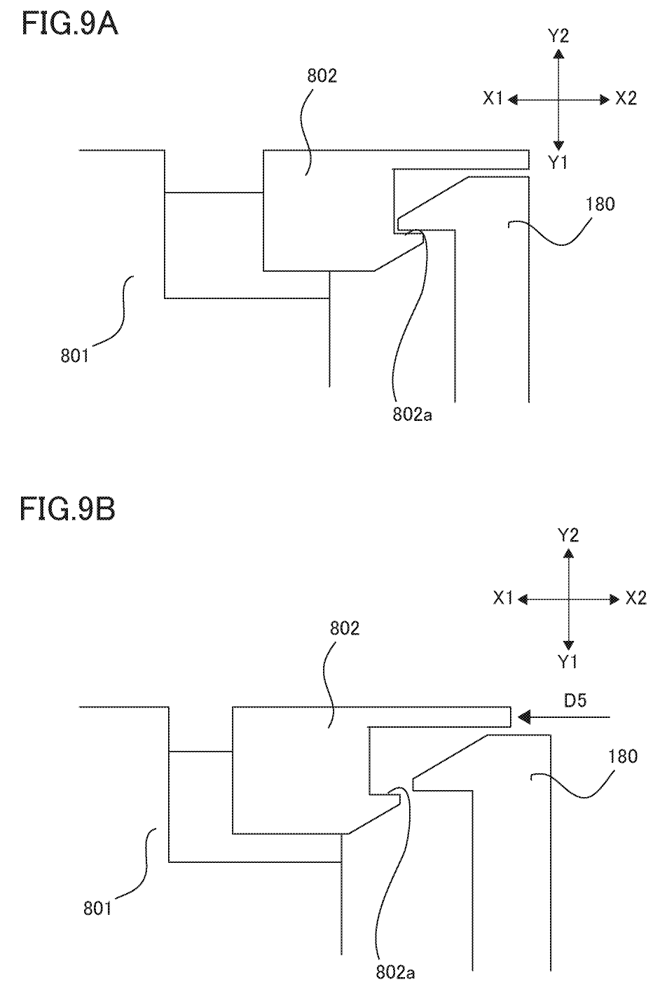

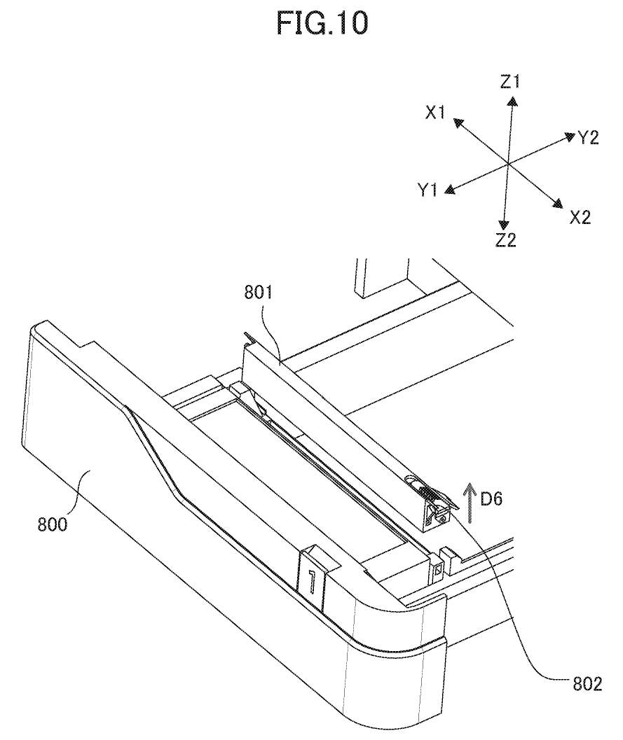

Next, using FIGS. 8 to 10, a disengagement configuration of a separation unit 801 will be described. FIG. 8 is a perspective view illustrating the image forming apparatus 1 in a state in which the cassette 800 is pulled out. FIG. 9A is a cross-sectional view illustrating a separation unit lock button 802, and FIG. 9B is a cross-sectional view illustrating a state in which the separation unit lock button 802 is pressed. FIG. 10 is a perspective view illustrating a state in which the separation unit 801 has been disengaged from the cassette 800.

As illustrated in FIG. 8, the cassette 800, serving as a drawer unit, is arranged beneath the multi-purpose tray 700, and the cassette 800 is configured to be pulled out in the Y1 direction and to be inserted in the Y2 direction with respect to the apparatus body A. In addition, the cassette 800 can stack the sheet.

The separation unit 801 is detachably supported with respect to the cassette 800, and the separation unit 801 includes a separation member 801a that is disposed in a position facing the sheet feed roller 3b. The separation member 801a separates the sheet, which has been fed from the cassette 800 by the sheet feed roller 3b, into one sheet at a time.

A separation unit lock button 802, serving as a second regulating portion, is disposed at an end portion in the X2 direction of the separation unit 801. FIGS. 9A and 9B are cross-sectional views illustrating a broken line portion of the FIG. 8. That is, FIGS. 9A and 9B are cross-sectional views taken along a plane parallel to the XY plane. As illustrated in FIG. 9A, in the apparatus body A, a separation unit engagement portion 180 is disposed, and a separation unit lock button 802 is supported on the separation unit 801 so as to be slidable in the X-axis direction. The separation unit lock button 802 is urged in the X2 direction by a spring, not shown, and is positioned at a lock position illustrated in FIG. 9A.

A lock portion 802a capable of engaging with the separation unit engagement portion 180 is disposed in the separation unit lock button 802. When the separation unit lock button 802 is positioned at the lock position, the lock portion 802a engages with the separation unit engagement portion 180. At this time, the lock portion 802a and the separation unit engagement portion 180 are arranged to overlap when viewed in the Y-axis direction. That is, the separation unit 801 is locked in a mounting position, and disengagement from the cassette 800 is restricted. Therefore, even if the user grips the separation unit 801 and draws the separation unit 801 in a D6 direction illustrated in FIG. 10, the separation unit 801 is retained in the cassette 800.

When disengaging the separation unit 801 from the cassette 800, as illustrated in FIG. 9B, the user presses the separation unit lock button 802 in a D5 direction. Thereby, the separation unit lock button 802 moves in the X1 direction. Then, the engagement between the lock portion 802a of the separation unit lock button 802 and the separation unit engagement portion 180 is released, and the disengagement restriction of the separation unit 801 from the cassette 800 by the separation unit engagement portion 180 is released. That is, by operating the separation unit lock button 802 in the D5 direction (X1 direction), the separation unit lock button 802 allows the separation unit 801 to be disengaged with respect to the cassette 800.

In this state, as illustrated in FIG. 10, by operating the separation unit 801 in the D6 direction parallel to the Z1 direction, the user can disengage the separation unit 801 from the cassette 800. The D5 direction, which is an operation direction of the separation unit lock button 802, is parallel to the X1 direction, and, as illustrated in FIG. 3, corresponds to the D2 direction, which is the operation direction of the power switch 500.

### Positional Relationship between Power Switch and Gripping Portion

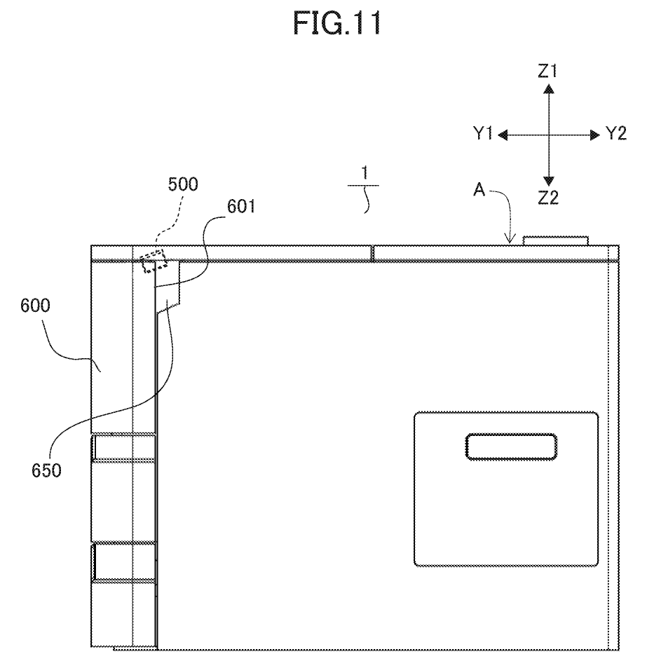

Next, using FIG. 11, a positional relationship between the power switch 500 and the gripping portion 601 will be described. FIG. 11 is a side view illustrating the positional relationship between the power switch 500 and the gripping portion 601. In FIG. 11, the power switch 500 is shown in a transparent view. As illustrated in FIG. 11, when viewed in the Y-axis direction, at least a portion of the power switch 500 is arranged to overlap the gripping portion 601 of the front door 600 which is positioned in the closed position. In addition, when viewed in the Y-axis direction, at least a portion of the power switch 500 is arranged to overlap the concave portion 650.

Thereby, it is possible to position the power switch 500 and the gripping portion 601 at substantially the same height from the installation surface of the image forming apparatus 1; therefore, it is possible to improve operability when operating the power switch 500 and the gripping portion 601, and it is possible to enhance usability.

### Operation Directions of Power Switch and Each Portion

As illustrated in FIG. 1B, the power switch 500 is operated in the D2 direction. In addition, a direction in which the user engages the hand on the gripping portion 601 is the D1 direction. In addition, as respectively described in FIGS. 3 and 8, the pressing directions of the door lock button 150, the tray lock button 701, and the separation unit lock button 802 are respectively the D3, D4, and D5 directions. Then, these D1, D2, D3, D4, and D5 directions are each parallel to the X1 direction, and are oriented in the same direction. The X1 direction, serving as a predetermined direction, is a direction from the side of the second end portion SD2 toward the side of the first end portion SD1 with respect to the X-axis direction.

Therefore, it is possible to enhance usability by unifying the operation direction of the power switch 500 with the operation directions of the gripping portion 601, the door lock button 150, the tray lock button 701, and the separation unit lock button 802. For example, any of these power switch 500, the gripping portion 601, the door lock button 150, the tray lock button 701, and the separation unit lock button 802 can be operated with one hand. It may be desirable that these members are operated with the right hand.

In addition, in a state in which the user faces the front of the image forming apparatus 1, the power switch 500 is operated in a lateral direction (X-axis direction). Therefore, when operating the gripping portion 601, the door lock button 150, the tray lock button 701, and the separation unit lock button 802 with one hand (e.g., right hand), the inadvertent manipulation of the power switch 500 with the other hand (e.g., left hand) can be suppressed.

In addition, as illustrated in FIG. 7, the release lever 702b is disposed on a side on which the second end portion SD2 of the apparatus body A is located with respect to a center CP1 of the multi-purpose tray 700 (or the sheet supporting surface 700a) in the Y-axis direction. For this reason, the user may operate the release lever 702b with the right hand. Therefore, when operating the release lever 702b with one hand (e.g., right hand), the user can suppress the inadvertent manipulation of the power switch 500 with the other hand (e.g., left hand).

In addition, since the display unit 400 is disposed above the front door 600, for example, even when the front door 600 is opened during jam processing, it is possible to ensure the visibility of the display unit 400.

### Second Embodiment

Next, a second embodiment of this disclosure will be described. In the second embodiment, the configurations of the display unit 400 and the power switch 500 of the first embodiment are modified. Therefore, illustrations of configurations similar to those of the first embodiment will be omitted, or will be described by putting the same reference characters on drawings.

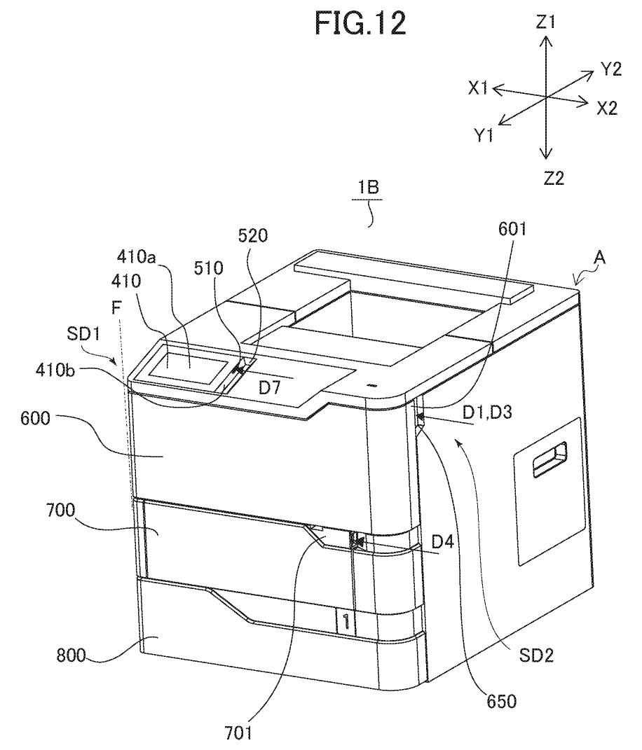

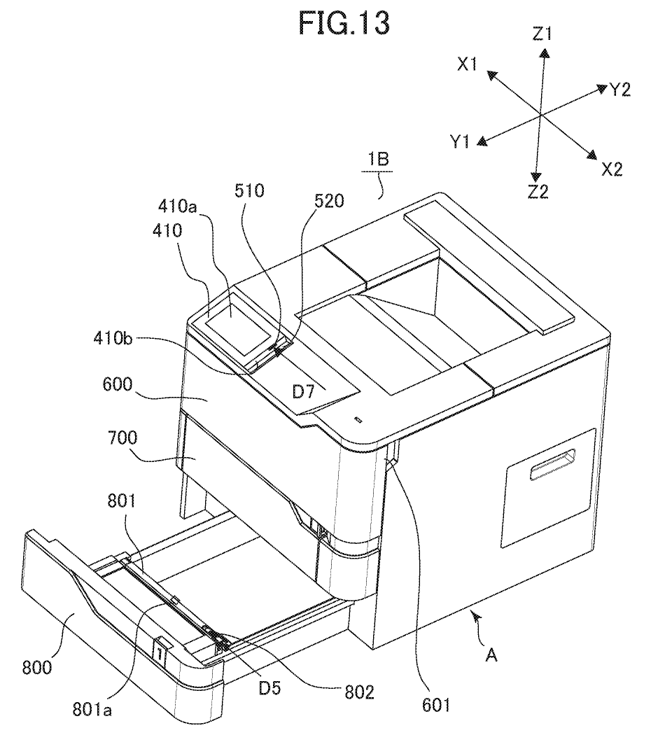

FIG. 12 is a perspective view illustrating an image forming apparatus 1B according to the second embodiment. FIG. 13 is a perspective view illustrating the image forming apparatus 1B with the cassette 800 pulled out. As illustrated in FIGS. 12 and 13, the apparatus body A of the image forming apparatus 1B includes a display unit 410 constituted from a touch panel. The display unit 410 includes a screen 410a capable of displaying various types of information. On the screen 410a, for example, it is possible to display notifications to the user such as replacement prompts for the process cartridge B or the toner cartridge C, error notifications such as paper jam occurrence, and status information for the apparatus body A such as during printing or upon print completion.

A groove portion 520 that is recessed in a normal direction of the screen 410a is disposed in the apparatus body A, and the groove portion 520 is disposed adjacent to the display unit 410. A power switch 510 is arranged on a side surface 410b on an upstream side in the X1 direction of the display unit 410. That is, the power switch 510 is arranged upstream in the X1 direction of the screen 410a of the display unit 410. In addition, it can be said that the power switch 510 is disposed adjacent to the groove portion 520. The groove portion 520 is disposed on the upstream side of the side surface 410b of the display unit 410 in the X1 direction so as to expose the power switch 510. By operating the power switch 510 in a D7 direction parallel to the X1 direction, it is possible to switch on and off a power supply of the image forming apparatus 1B.

By disposing the power switch 510 on the display unit 410, which is constituted from the touch panel as in this embodiment, it is possible to construct the image forming apparatus 1B at lower cost compared to disposing the power switch 510 on the apparatus body A. This is because, for example, it is possible to configure the wiring connecting the power switch 510 and a control unit to be shorter.

### Positional Relationship between Power Switch and Gripping Portion

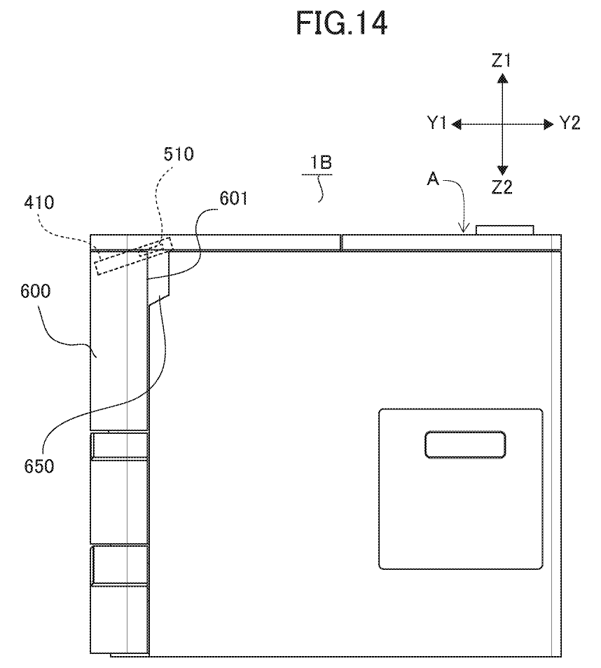

Next, using FIG. 14, a positional relationship between the power switch 510 and the gripping portion 601 will be described. FIG. 14 is a side view illustrating the positional relationship between the power switch 510 and the gripping portion 601. In FIG. 14, the display unit 410 and the power switch 510 are shown in a transparent view. As illustrated in FIG. 14, when viewed in the Y-axis direction, at least a portion of the power switch 510 is arranged to overlap the gripping portion 601 of the front door 600 which is positioned in the closed position. In addition, when viewed in the Y axis direction, at least a portion of the power switch 510 is arranged to overlap the concave portion 650.

Thereby, it is possible to position the power switch 510 and the gripping portion 601 at substantially the same height from an installation surface of the image forming apparatus 1B; therefore, it is possible to improve operability when operating the power switch 510 and the gripping portion 601, and it is possible to enhance usability.

### Operation Directions of Power Switch and Each Portion

As illustrated in FIGS. 12 and 13, the power switch 510 is operated in the D7 direction. In addition, the direction in which the user engages the hand on the gripping portion 601 is the D1 direction. In addition, as respectively described in FIGS. 3 and 8, the pressing directions of the door lock button 150, the tray lock button 701, and the separation unit lock button 802 are respectively the D3, D4, and D5 directions. Then, these D1, D7, D3, D4, and D5 directions are each parallel to the X1 direction, and are oriented in the same direction.

Therefore, it is possible to enhance usability by unifying the operation direction of the power switch 510 with the operation directions of the gripping portion 601, the door lock button 150, the tray lock button 701, and the separation unit lock button 802. In addition, it is possible to achieve the same effects as those of the first embodiment.

### Other Embodiments

To be noted, in any of the embodiments described above, the power switch 500, 510 is arranged above the front door 600 and on the front side of the apparatus body A; however, it is not limited to this. For example, the power switch 500, 510 may be disposed on a side surface or a top surface of the apparatus body A, or may be disposed in the lower direction of the front door 600.

In addition, in any of the embodiments described above, the power switch 500, 510 is disposed upstream of the screen 401, 410a in the X1 direction; however, it is not limited to this. For example, the power switch 500, 510 may be disposed downstream of the screen 401, 410a in the X1 direction, or may be disposed in a position that overlaps the screen 401, 401a in the X1 direction.

According to this disclosure, it is possible to enhance usability.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of priority from Japanese Patent Application No. 2025-030776, filed February 27, 2025, which is hereby incorporated by reference herein in its entirety.

What is claimed is:

1. An image forming apparatus comprising:
an apparatus body including an opening portion;
a process cartridge including a photosensitive drum which is configured to rotate around a rotational axis, the process cartridge being configured to be detachably mounted to the apparatus body through the opening portion;
an opening/closing member configured to be pivotably supported by the apparatus body around a pivot axis, the pivot axis being positioned in a first end portion of the apparatus body opposite to a second end portion of the apparatus body in a direction of the rotational axis, and extending along a gravity direction, the opening/closing member being pivotable between a closed position where the opening/closing member covers the opening portion and an open position where the opening/closing member opens the opening portion; and
a power switch disposed on the apparatus body,
wherein the opening/closing member includes a gripping portion configured to be gripped when the opening/closing member is operated from the closed position toward the open position, the gripping portion being disposed on a side of the second end portion opposite to the first end portion of the apparatus body in a case where the opening/closing member is positioned in the closed position, and
wherein the power switch is configured to switch on and off a power supply of the image forming apparatus by being operated in a predetermined direction from the second end portion toward the first end portion with respect to the direction of the rotational axis.

2. The image forming apparatus according to claim 1, wherein, when viewed in the direction of the rotational axis, at least a portion of the power switch is disposed to overlap the gripping portion of the opening/closing member which is positioned in the closed position.

3. The image forming apparatus according to claim 1, wherein the power switch is disposed above the opening/closing member.

4. The image forming apparatus according to claim 1, wherein the apparatus body includes a concave portion that is recessed in the predetermined direction, and
wherein the concave portion is disposed in the second end portion, and is arranged adjacent to the gripping portion of the opening/closing member which is positioned in the closed position.

5. The image forming apparatus according to claim 1, wherein the apparatus body includes a display unit disposed above the opening/closing member, the display unit including a screen, and
wherein the power switch is disposed upstream of the screen of the display unit in the predetermined direction.

6. The image forming apparatus according to claim 5, wherein the display unit includes a touch panel, and
wherein the power switch is disposed on a side surface of the touch panel, the side surface being an upstream surface of the touch panel in the predetermined direction.

7. The image forming apparatus according to claim 6, wherein the apparatus body includes a groove portion recessed in a normal direction of the screen, and
wherein the groove portion is disposed upstream of the side surface of the touch panel in the predetermined direction so as to expose the power switch.

8. The image forming apparatus according to claim 1, wherein the pivot axis is a first pivot axis,
wherein the image forming apparatus further comprises:
a sheet supporting portion supported with respect to the apparatus body so as to be openable and closable around a second pivot axis extending in the direction of the rotational axis, the sheet supporting portion being configured to support a sheet in a state of being opened with respect to the apparatus body; and
a first regulating portion configured to restrict the sheet supporting portion from being opened with respect to the apparatus body, and
wherein the first regulating portion is configured to allow the sheet supporting portion to be opened with respect to the apparatus body by being operated in the predetermined direction.

9. The image forming apparatus according to claim 8, further comprising a moving unit movably supported with respect to the sheet supporting portion in the direction of the rotational axis,
wherein the moving unit includes:
a regulating surface configured to restrict a position of the sheet supported on the sheet supporting portion in the direction of the rotational axis; and
a release lever configured to allow movement of the moving unit with respect to the sheet supporting portion, and
wherein the release lever is disposed on a side on which the second end portion is located with respect to a center of the sheet supporting portion in the direction of the rotational axis.

10. The image forming apparatus according to claim 1, further comprising:
a drawer unit attached to the apparatus body to be pullable out from the apparatus body and configured to support a sheet;
a separation unit detachably supported with respect to the drawer unit; and
a second regulating portion configured to restrict detachment of the separation unit with respect to the drawer unit,
wherein the second regulating portion is configured to allow the detachment of the separation unit with respect to the drawer unit by being operated in the predetermined direction.
